(19) United States
(12) Patent Application Publication
(10) Pub. No.: US 2018/0100799 A1
(43) Pub. Date: Apr. 12, 2018

(54) SAMPLE ANALYSIS TOOL EMPLOYING A BROADBAND ANGLE-SELECTIVE FILTER

(71) Applicant: Halliburton Energy Services, Inc., Houston, TX (US)

(72) Inventors: James M. Price, Spring, TX (US); David L. Perkins, The Woodlands, TX (US)

(21) Appl. No.: 15/556,340

(22) PCT Filed: Aug. 12, 2015
(86) PCT No.: PCT/US2015/044910

§ 371 Date: Sep. 7, 2017

(30) Foreign Application Priority Data
Apr. 15, 2015 (US) PCT/US2015/025866
Apr. 15, 2015 (US) PCT/US2015/025869
Apr. 15, 2015 (US) PCT/US2015/025922

(51) Int. Cl. G01N 21/49; E21B 49/08; E21B 47/00

(52) U.S. Cl. CPC G01N 21/49; G01N 2021/215; E21B 47/00; E21B 49/088

(57) ABSTRACT

A sample analysis tool includes a sample chamber to hold a sample. The tool also includes a broadband angle-selective filter arranged along an optical path with the sample chamber. The tool also includes an electromagnetic radiation (ER) transducer that outputs a signal in response to electromagnetic radiation that passes through the broadband angle-selective filter. The tool also includes a storage device that stores data corresponding to the signal output from the ER transducer, wherein the data indicates a property of the sample.

### BACKGROUND

Various tools exist to analyze samples using electromagnetic radiation. One example sample analysis tool, referred to as a photometer, provides information regarding how properties of electromagnetic radiation are affected due to being reflected off of, emitted from, or passed through a sample. Another example tool, referred to as a ellipsometer, provides information regarding how the polarity of electromagnetic radiation is affected due to being reflected off of or passed through a sample. Another example tool, referred to as a spectrometer, provides information regarding how particular wavelengths of electromagnetic radiation are affected due to being reflecting off of, emitted from, or passed through a sample. Previous efforts to improve the performance of sample analysis tools include careful arrangement of spatial masking components, imaging optics, and/or lenses along an optical path. In a downhole environment, the available space for sample analysis tool components is limited. Efforts to improve the performance of sample analysis tools, in particular, when spacing constraints and/or extreme environments are an issue are ongoing.

### BRIEF DESCRIPTION OF THE DRAWINGS

Accordingly, there are disclosed herein sample analysis tools and methods employing a broadband angle-selective filter. In the drawings:

FIG. 1 shows an illustrative sample analysis tool;

FIG. 2A shows an illustrative drilling environment;

FIG. 2B shows an illustrative wireline logging environment;

FIGS. 3A and 3B show illustrative sample analysis tool configurations; and

FIG. 4 shows an illustrative sample analysis method.

It should be understood, however, that the specific embodiments given in the drawings and detailed description below do not limit the disclosure. On the contrary, they provide the foundation for one of ordinary skill to discern the alternative forms, equivalents, and other modifications that are encompassed in the scope of the appended claims.

### DETAILED DESCRIPTION

Disclosed herein are sample analysis tools and related methods employing a broadband angle-selective filter. As used herein, the term “broadband angle-selective filter” refers to an optical component that allows electromagnetic radiation at a wide range of frequencies to pass though it, but only at a particular incident angle or narrow range of incident angles. Without limitation, a documented broadband angle-selective filter is 98% transparent to p-polarized electromagnetic radiation at an angle of 55°+/−about 4°. See Yichen Shen et al., Optical Broadband Angular Selectivity, Science 343, 1499 (2014). The use of a broadband angle-selective filter in sample analysis tools (e.g., photometers, ellipsometers, and spectrometers) provides new design options that could enhance or replace existing sample analysis tools designs.

In at least some embodiments, an example sample analysis tool includes a sample chamber to hold a sample. The tool also includes a broadband angle-selective filter arranged along an optical path with the sample chamber. The tool also includes an electromagnetic radiation (ER) transducer (a detector) that outputs a signal in response to electromagnetic radiation that passes through the broadband angle-selective filter. The tool also includes a storage device that stores data corresponding to the signal output from the ER transducer, wherein the data indicates a property of the sample. Meanwhile, an example fluid analysis method includes arranging a sample and a broadband angle-selective filter along an optical path. The method also includes outputting a signal in response to electromagnetic radiation that passes through the broadband angle-selective filter. The method also includes storing data corresponding to the signal, wherein the data indicates a property of the sample. Various sample collection options, sample analysis tool configuration options, data storage and analysis options, and downhole scenario options are described herein.

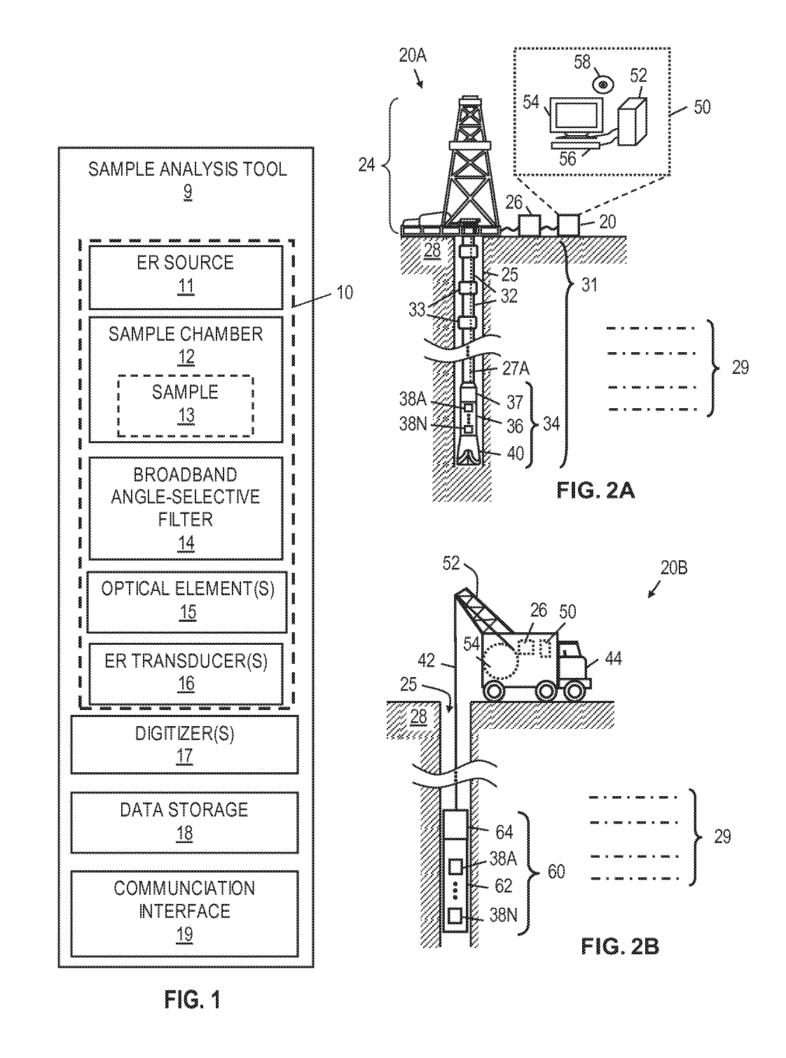

The disclosed methods and systems are best understood when described in an illustrative usage context. FIG. 1 shows an illustrative sample analysis tool 9. The sample analysis tool 9 includes an ER source 11, sample chamber 12, a broadband angle-selective filter 14, optical element 15, and at least one ER transducer 16 arranged along an optical path 10. The arrangement and orientation of the components deployed along the optical path 10 may vary. Further, the optical path 10 does not necessarily correspond to a straight path (e.g., there may be corners, curves, or other directional changes along the optical path 10). Further, the sample analysis tool 9 may include spatial masking components, imaging optics, and/or lenses along the optical path 10. Alternatively, such components can be omitted depending on the arrangement of the broadband angle-selective filter 14 and the ER transducer(s) 16. In some embodiments, one ER transducer 16 detects electromagnetic radiation that has passed through the broadband angle-selective filter 14, while a supplemental ER transducer 16 detects scattered electromagnetic radiation or non-specular electromagnetic radiation that does not pass through the broadband angle-selective filter 14.

In some embodiments, the ER source 11 can be omitted if electromagnetic radiation external to the sample analysis tool 9 is available. Further, in some embodiments, a sample 13 within sample chamber 12 is capable of emitting electromagnetic radiation (e.g., through a transparent window of the sample chamber 12) and can serve as the ER source 11. Further, in some embodiments, the optical element 15 corresponds to one or more of an optical filter, a polarizing element, or a wavelength selection element. For example, optical element 15 can be an optical filter that allows transmission of electromagnetic radiation in a particular wavelength band (e.g., 550-560 nm, 1000-1100 nm, or 2300-3200 nm) if the sample analysis tool 9 corresponds to a photometer. Further, in some embodiments, the optical element 15 can be a wavelength selection element that filters as a function of wavelength may be included if the sample analysis tool 9 corresponds to a spectrometer. Further, in some embodiments, the optical element 15 can be a polarizing element that filters as a function of polarization may be included if the sample analysis tool 9 corresponds to an ellipsometer. In some embodiments, the optical element 15 may correspond to a combination of an optical filter, a polarizing element, and/or a wavelength selection element.

In at least some embodiments, the sample analysis tool 9 also includes at least one digitizer 17 to convert analog signals from each detector 16 to a corresponding digital signal. Further, the sample analysis tool 9 may include data storage 18 to store data corresponding to the output of each ER transducer 16. As another option, the sample analysis tool 9 may include a communication interface 19 to convey data corresponding to the output of each detector 16 to another device. Additionally or alternatively, the sample analysis tool 9 may include a processing unit (not shown) to process data and/or a display unit (not shown) to display data corresponding to the output of each detector 16. For example, the data corresponding to the output of each ER transducer 16 may be analyzed to identify a property of the sample 13. As example, the identified property may correspond to a density (or other physical parameter) and/or a chemical component. The identified property may be displayed via a display unit and/or may be transmitted using the communication interface 19 to another device. The configuration of the sample analysis tool 9 may vary depending on the environment in which the sample analysis tool 9 is used. For example, a downhole configuration for the sample analysis tool 9 may differ from a laboratory configuration for the sample analysis tool 9 due to spatial constraints, sampling constraints, power constraints, ambient parameters (temperature, pressure, etc.), or other factors.

Further, it should be appreciated that the sample analysis tool 9 may include components for obtaining a sample. For example, to sample fluid in a downhole environment, the sample analysis tool 9 may include a sampling interface that extends to a borehole wall and draws fluid from a formation. Further, the sampling interface may direct the formation fluid to the sample chamber 12. As desired, obtained samples can be stored for later analysis once a sample analysis tool 9 is retrieved (e.g., from a downhole environment) or the samples can be flushed to allow for analysis of a subsequent sample while the sample analysis tool 9 remains in a downhole environment. Further, it should be appreciated that the sample analysis tool 9 may include components for controlling the pressure or temperature of a sample during analysis.

FIG. 2A shows an illustrative drilling environment 20A. In FIG. 2A, a drilling assembly 24 enables a drill string 31 to be lowered and raised in a borehole 25 that penetrates formations 29 of the earth 28. The drill string 31 is formed, for example, from a modular set of drill string segments 32 and adaptors 33. At the lower end of the drill string 31, a bottomhole assembly 34 with a drill bit 40 removes material from the formations 29 using known drilling techniques. The bottomhole assembly 34 also includes one or more drill collars 37 and a downhole tool 36 with one or more sample analysis units 38A-38N, each of which may correspond to some variation of the sample analysis tool 9 described for FIG. 1. To collect fluid samples in the drilling environment 20A, a sampling interface (not shown) is included with the downhole tool 36. For example, the sampling interface may be integrated with a drill collar 37 close to drill bit 40. As needed, the drilling operations can be halted to allow fluid samples to be obtained using known sampling techniques.

In addition to the sample analysis units 38A-38N, the downhole tool 36 may also include electronics for data storage, communication, etc. In different embodiments, sample analysis measurements obtained by the one or more sample analysis units 38A-38N are conveyed to earth's surface using known telemetry techniques (e.g., wired pipe telemetry, mud pulse telemetry, acoustic telemetry, electromagnetic) and/or are stored by the downhole tool 36. In at least some embodiments, a cable 27A may extend from the BHA 34 to earth's surface. For example, the cable 27A may take different forms such as embedded electrical conductors and/or optical waveguides (e.g., fibers) to enable transfer of power and/or communications between the bottomhole assembly 34 and earth's surface. In other words, the cable 27A may be integrated with, attached to, or inside the modular components of the drill string 31.

In FIG. 2A, an interface 26 at earth's surface receives sample analysis measurements (or other data collected downhole) via cable 27A or another telemetry channel and conveys the sample analysis measurements to a computer system 50. In some embodiments, the surface interface 26 and/or the computer system 50 may perform various operations such as converting signals from one format to another, storing sample analysis measurements and/or processing sample analysis measurements to recover information about properties of a sample. As an example, in at least some embodiments, the computer system 50 includes a processing unit 52 that displays sample analysis measurements or related sample properties by executing software or instructions obtained from a local or remote non-transitory computer-readable medium 58. The computer system 50 also may include input device(s) 56 (e.g., a keyboard, mouse, touchpad, etc.) and output device(s) 54 (e.g., a monitor, printer, etc.). Such input device(s) 56 and/or output device(s) 54 provide a user interface that enables an operator to interact with the downhole tool 36 and/or software executed by the processing unit 52. For example, the computer system 50 may enable an operator to select sampling options, to select sample analysis options, to view collected sample analysis measurements, to view sample properties obtained from the sample analysis measurements, and/or to perform other tasks. Further, information about the downhole position at which a particular sample is collected may be taken into account and used to facilitate well completion decisions and/or other strategic decisions related to producing hydrocarbons.

At various times during the drilling process, the drill string 31 shown in FIG. 2A may be removed from the borehole 25. With the drill string 31 removed, another option for performing sample analysis operations involves the wireline environment 20B of FIG. 2B. In FIG. 2B, a wireline tool string 60 is suspended in a borehole 25 that penetrates formations 29 of the earth 28. For example, the wireline tool string 60 may be suspended by a cable 42 having conductors and/or optical fibers for conveying power to the wireline tool string 60. The cable 42 may also be used as a communication interface for uphole and/or downhole communications. In at least some embodiments, the cable 42 wraps and unwraps as needed around cable reel 54 when lowering or raising the wireline tool string 60. As shown, the cable reel 54 may be part of a movable logging facility or vehicle 42 having a cable guide 52.

In at least some embodiments, the wireline tool string 60 includes logging tool(s) 64 and a downhole tool 62 with one or more sample analysis units 38A-38N, each of which may correspond to some variation of the sample analysis tool 9 described for FIG. 1. The downhole tool 62 may also include electronics for data storage, communication, etc. The sample analysis measurements obtained by the one or more sample analysis units 38A-38N are conveyed to earth's surface and/or are stored by the downhole tool 62. In either case, the sample analysis measurements can be used to determine one or more properties of a sample collected in the downhole environment. For example, the sample analysis measurements may be used to determine a sample density, to identify presence or absence of a chemical, and/or to determine another property of a sample. Further, information about the downhole position at which a particular sample was collected may be taken into account and used to facilitate well completion decisions and/or other strategic decisions related to producing hydrocarbons.

At earth's surface, a surface interface 26 receives the sample analysis measurements via the cable 42 and conveys the sample analysis measurements to a computer system 50. As previously discussed, the interface 26 and/or computer system 50 (e.g., part of the movable logging facility or vehicle 44) may perform various operations such as converting signals from one format to another, storing the sample analysis measurements, processing the sample analysis measurements, displaying the sample analysis measurements or related sample properties, etc.

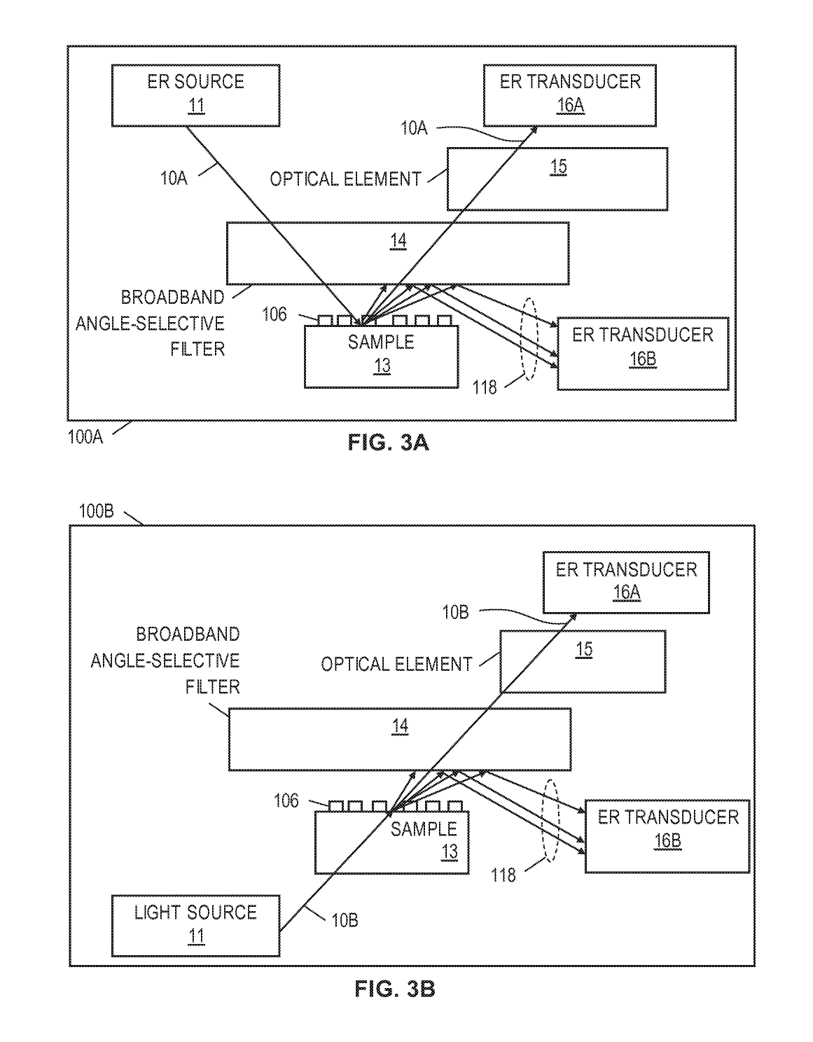

FIGS. 3A and 3B show illustrative sample analysis tool configurations. In FIG. 3A, sample analysis tool 100A includes a broadband angle-selective filter 14 that is between ER source 11 and sample 13. With this configuration, the electromagnetic radiation to be analyzed corresponds to the optical path 10A, where electromagnetic radiation emitted from the ER source 11 passes through the broadband angle-selective filter 14, reflects off of sample 13, passes through the broadband angle-selective filter 14 again, passes through optical element 15, and arrives to ER transducer 16A. As shown, the sample analysis tool 100A also includes an ER transducer 16B that detects scattered or non-specular electromagnetic radiation 118 that is reflected at the surface of the sample 13 at angles that cause the scattered or non-specular electromagnetic radiation 118 to reflect off of the broadband angle-selective filter 14 rather than pass through it. In at least some embodiments, the scattered or non-specular electromagnetic radiation 118 is due to the sample 13 having non-planar and/or non-laminar structures 106 along its surface. The signals output by the ER transducer 16A and/or the ER transducer 16B in response to incident electromagnetic radiation are digitized, stored, and analyzed to characterize a property of the sample 13 as described herein. In at least some embodiments, the relative intensities of the electromagnetic radiation detected by ER transducer 16A and 16B can be compared to characterize a property of the sample 13.

In FIG. 3B, sample analysis tool 100B includes a sample 13 that is between ER source 11 and broadband angle-selective filter 14. With this configuration, the electromagnetic radiation to be analyzed corresponds to the optical path 10B, where electromagnetic radiation emitted from the ER source 11 passes through the sample 13, passes through the broadband angle-selective filter 14, passes through optical element 15, and arrives to ER transducer 16A. As shown, the sample analysis tool 100B also includes a ER transducer 16B that detects scattered or non-specular electromagnetic radiation 118 that is reflected at the surface of the sample 13 at angles that cause the scattered or non-specular electromagnetic radiation to reflect off of the broadband angle-selective filter 14 rather than pass through it. In at least some embodiments, the scattered or non-specular electromagnetic radiation 118 is due to the sample 13 having non-planar and or non-laminar structures 106 along its surface. The signals output by the ER transducer 16A and/or the ER transducer 16B in response to incident electromagnetic radiation are digitized, stored, and analyzed to characterize a property of the sample 13 as described herein. In at least some embodiments, the relative intensities of the electromagnetic radiation detected by ER transducer 16A and 16B can be compared to characterize a property of the sample 13.

In at least some embodiments, the broadband angle-selective filters 14 described herein can be used in combination with available spatial masking techniques. Alternatively, the broadband angle-selective filters 14 described herein correspond to thin film stacks that could be integrated with optical element 15, ER transducer 16, or sampling window to screen out non-specular incident electromagnetic radiation. Since the principle of angle-selective filters relies on exploiting the Brewster angle for the film stack design, in scenarios where only P-polarized electromagnetic radiation is transmitted, at least one polarizer may be placed after the broadband angle-selective filters 14 to capture only the P-polarized electromagnetic radiation.

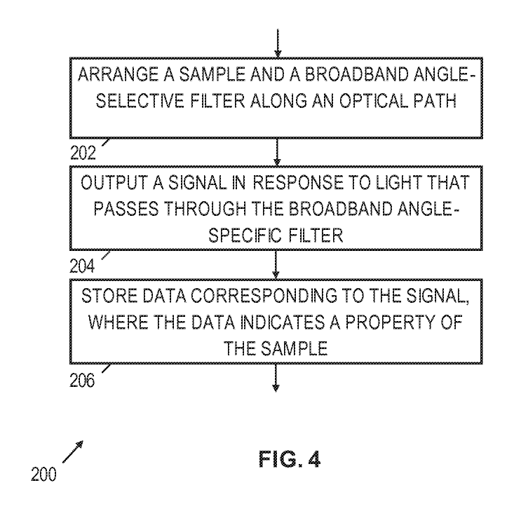

FIG. 4 shows an illustrative sample analysis method 200. As shown, method 200 comprises arranging a sample and a broadband angle-selective filter along an optical path at block 202. As described herein, the sample may be between an ER source and the broadband angle-selective filter. Alternatively, the broadband angle-selective filter may be between an ER source and the sample. At block 204, a signal is output in response to electromagnetic radiation that passes through the broadband angle-selective filter. The signal may be output, for example, by an ER transducer. At block 206, data corresponding to the signal is stored, where the data indicates a property of the sample. As described herein, in some embodiments, ER transducers positioned on opposite sides of a broadband angle-selective filter may be employed and their respective signals compared to perform sample analysis. In such case, blocks 204 and 206 may involve outputting and storing multiple signals.

In one embodiment, the sample analysis method 200 corresponds to the operation of a photometer that provides information regarding how the intensity of electromagnetic radiation is affected due to being reflected off of, emitted from, or passed through a sample.

In another embodiment, the sample analysis method 200 corresponds to the operation of an ellipsometer that provides information regarding how the polarization of electromagnetic radiation is affected due to being reflected off of or passed through a sample. In yet another embodiment, the sample analysis method 200 corresponds to the operation of a spectrometer that provides information regarding how particular wavelengths of electromagnetic radiation are affected due to being reflecting off of, emitted from, or passed through a sample. The sample analysis method 200 may be performed downhole as described herein or at earth's surface (e.g., in a laboratory).

Embodiments disclosed herein include:

A: A sample analysis tool comprises a sample chamber to hold a sample. The tool also comprises a broadband angle-selective filter arranged along an optical path with the sample chamber. The tool also comprises an ER transducer that outputs a signal in response to electromagnetic radiation that passes through the broadband angle-selective filter. The tool also comprises a storage device that stores data corresponding to the signal output from the ER transducer, wherein the data indicates a property of the sample.

B: A sample analysis method comprises arranging a sample and a broadband angle-selective filter along an optical path. The method also comprises outputting a signal in response to electromagnetic radiation that passes through the broadband angle-selective filter. The method also comprises storing data corresponding to the signal, wherein the data indicates a property of the sample.

Each of the embodiments, A and B, may have one or more of the following additional elements in any combination. Element 1: further comprising a housing and an ER source within the housing. Element 2: wherein the sample is exposed to an ER source and wherein the data indicates a property of the sample. Element 3: wherein the sample emits electromagnetic radiation and wherein the data indicates a property of the sample. Element 4: wherein the broadband angle-selective filter and the ER transducer are arranged within the tool to prevent scattered electromagnetic radiation or non-specular electromagnetic radiation from arriving to the ER transducer. Element 5: further comprising a supplemental ER transducer to output a supplemental signal in response to an amount of scattered electromagnetic radiation or non-specular electromagnetic radiation that does not pass through the broadband angle-selective filter, wherein data corresponding to the supplemental signal is used to determine the property of the sample. Element 6: further comprising a polarizer positioned between the broadband angle-selective filter and the ER transducer. Element 7: wherein the sample analysis tool corresponds to a photometer. Element 8: wherein the sample analysis tool corresponds to a spectrometer. Element 9: wherein the sample analysis tool corresponds to an ellipsometer. Element 10: wherein the sample analysis tool is deployed in a downhole environment.

Element 11: further comprising exposing the sample to an ER source. Element 12: further comprising using the sample as an ER source. Element 13: further comprising polarizing electromagnetic radiation that passes through the broadband angle-selective filter, wherein the signal is affected by the polarizing. Element 14: further comprising filtering electromagnetic radiation that passes through the broadband angle-selective filter as a function of wavelength, wherein the signal is affected by the filtering. Element 15: further comprising outputting a supplemental signal representative of scattered electromagnetic radiation or non-specular electromagnetic radiation that does not pass through the broadband angle-selective filter. Element 16: further comprising collecting the sample in a downhole environment before said arranging, outputting, and storing. Element 17: wherein said arranging, outputting, and storing are performed in a downhole environment. Element 18: conveying the data from a downhole environment to a surface computer, wherein the surface computer displays information regarding the property of the sample.

Numerous other variations and modifications will become apparent to those skilled in the art once the above disclosure is fully appreciated. It is intended that the following claims be interpreted to embrace all such variations and modifications where applicable.

1. A sample analysis tool, comprising:
a sample chamber to hold a sample;
a broadband angle-selective filter arranged along an optical path with the sample chamber;
an electromagnetic radiation (ER) transducer that outputs a signal in response to electromagnetic radiation that passes through the broadband angle-selective filter; and
a storage device that stores data corresponding to the signal output from the ER transducer, wherein the data indicates a property of the sample.

2. The tool of claim 1, further comprising a housing and an ER source within the housing.

3. The tool of claim 1, wherein the sample is exposed to an ER source and wherein the data indicates a property of the sample.

4. The tool of claim 1, wherein the sample emits electromagnetic radiation and wherein the data indicates a property of the sample.

5. The tool of claim 1, wherein the broadband angle-selective filter and the ER transducer are arranged within the tool to prevent scattered electromagnetic radiation or non-specular electromagnetic radiation from arriving to the ER transducer.

6. The tool of claim 1, further comprising a supplemental ER transducer to output a supplemental signal in response to an amount of scattered electromagnetic radiation or non-specular electromagnetic radiation that does not pass through the broadband angle-selective filter, wherein data corresponding to the supplemental signal is used to determine the property of the sample.

7. The tool of claim 1, further comprising a polarizer positioned between the broadband angle-selective filter and the ER transducer.

8. The tool according to claim 1, wherein the sample analysis tool corresponds to a photometer.

9. The tool according to claim 1, wherein the sample analysis tool corresponds to a spectrometer.

10. The tool according to claim 1, wherein the sample analysis tool corresponds to an ellipsometer.

11. The tool according to claim 1, wherein the sample analysis tool is deployed in a downhole environment.

12. A sample analysis method, comprising:
arranging a sample and a broadband angle-selective filter along an optical path;
outputting a signal in response to electromagnetic radiation that passes through the broadband angle-selective filter; and
storing data corresponding to the signal, wherein the data indicates a property of the sample.

13. The method of claim 12, further comprising exposing the sample to an electromagnetic radiation source.

14. The method of claim 12, further comprising using the sample as an electromagnetic radiation source.

15. The method of claim 12, further comprising polarizing electromagnetic radiation that passes through the broadband angle-selective filter, wherein said signal is affected by said polarizing.

16. The method of claim 12, further comprising filtering electromagnetic radiation that passes through the broadband angle-selective filter as a function of wavelength, wherein said signal is affected by said filtering.

17. The method of claim 12, further comprising outputting a supplemental signal representative of scattered electromagnetic radiation or non-specular electromagnetic radiation that does not pass through the broadband angle-selective filter.

18. The method according to claim 12, further comprising collecting the sample in a downhole environment before said arranging, outputting, and storing.

19. The method according to claim 12, wherein said arranging, outputting, and storing are performed in a downhole environment.

20. The method according to claim 12, further comprising conveying the data from a downhole environment to a surface computer, wherein the surface computer displays information regarding the property of the sample.
